(19) United States
(12) Patent Application Publication
(10) Pub. No.: US 2010/0014406 A1
(43) Pub. Date: Jan. 21, 2010

(54) RECORDING CONDITION ADJUSTING METHOD AND OPTICAL DISC APPARATUS

(76) Inventors: Masatsugu Ogawa, Tokyo (JP); Masaki Nakano, Tokyo (JP)

Correspondence Address: Mr. Jackson Chen, 6535 N. STATE HWY 161, IRVING, TX, 75039, US

(21) Appl. No.: 12/527,649

(22) PCT Filed: Jan. 25, 2008
(86) PCT No.: PCT/JP2008/051068

§ 371 Date: Aug. 18, 2009

(30) Foreign Application Priority Data
Feb. 19, 2007 (JP) 2007-037590

(51) Int. Cl. G11B 7/0045

(52) U.S. Cl. 369/59.11; G9B/7.01

(57) ABSTRACT

An optical disc apparatus according to the present invention includes a recording strategy adjusting section having an initial value setting section; an output level setting section; and a pulse width setting section. The initial value setting section sets initial values of pulse widths and output levels of a laser beam as a basic recording strategy. Also, the output level setting section adjusts output levels of the recording strategy with a plurality of first adjustment laser beams that are outputted by changing the output levels of the basic recording strategy. Also, the pulse width setting section adjusts the output levels of the recording strategy with a plurality of second adjustment laser beams that are outputted by fixing the output levels set by the initial value setting section, and changing the pulse widths of the basic recording strategy.

### TECHNICAL FIELD

The present invention relates to a recording condition adjustment method for an optical information recording medium and an optical disc apparatus using the method, and more particularly, to a recording condition adjustment method for a high-density optical information recording medium and an optical disc apparatus. It should be noted that this application claims a priority on convention based on Japanese patent application No. 2007-37590, and disclosed thereof is incorporated herein by reference.

### BACKGROUND ART

Currently, in an optical disc apparatus that uses an optical disc (optical information recording medium) to record or reproduce information, a read signal is detected from a laser beam, which is modulated and reflected on a recording surface of the optical disc, to obtain various types of information. In a reproduction-only optical disc, a variation in an amount of reflected beam that is reflected by a rugged pit (prepit) formed in advance on a recording surface is used to extract a read signal. Also, in a write-once optical disc, a variation in an amount of reflected beam caused by a variation in state of a fine pit or a recording mark formed by high power laser irradiation is used to extract a read signal. Further, in a phase change optical disc that is one of rewritable optical discs, a variation in an amount of reflected beam caused by a phase change of a recording mark is used to extract a read signal. The write-once type of disc and the rewritable type of disc may be collectively referred to as a recordable type.

In an optical disc apparatus, factors dominating performance upon recording or reproduction include a control of an optical beam forming a recording mark. The control of the optical beam generally includes a control of an output level of a recording power, bias power, or the like, and a control of a pulse width (time direction) of a recording laser beam. The waveform of the recording laser beam is generally referred to as a recording strategy. However, the output level and pulse width of the recording laser beam, which determine the waveform of the recording laser beam, are referred to as a recording strategy in the following description.

There are various types of recording strategies, and depending on a medium to be recorded, an output level or a pulse shape may be different. To improve recording performance on an optical disc, a pulse train type recording strategy formed by multi-pulse modulation is effective. FIG. 1 illustrates examples of the pulse train type recording strategy. The pulse train type recording strategy includes only a top pulse for a 2T signal, a top pulse and a last pulse for a 3T signal, or a top pulse, a middle pulse, and a last pulse for 4T or longer signal (T: channel clock period). Thus, distribution of heat generated in a recording mark can be controlled. (a) and (b) of FIG. 1 are diagrams illustrating examples of the recording strategy employed in a write-once optical recording medium (e.g., DVD-R). The recording strategy illustrated in (a) of FIG. 1 is controlled by a recording power P_{w} and a bias power P_{b}. The recording strategy illustrated in (b) of FIG. 1 is controlled by different recording powers P_{w}1, P_{w}2, and P_{w}3 of the top pulse, the middle pulse, and the last pulse, respectively. (c) of FIG. 1 is a diagram illustrating an example of the recording strategy employed in a rewritable optical recording medium (e.g., DVD-RW). The recording strategy illustrated in (c) of FIG. 1 is controlled by output levels of the recording power P_{w}, the bias power P_{b}, and an erasing power so as to be overwritable (multi-pulse type). Also, this recording strategy has a cooling pulse after a last pulse to enhance a cooling effect upon recording. It should be noted that an output level in a space where a recording mark is not formed is referred to as the bias power for the write-once optical recording medium, or the erasing power for the rewritable optical recording medium because it has an action of erasing a pre-existing recording mark.

In case of an HD DVD (High Definition DVD) as a next-generation DVD that starts to be delivered recently, both of a write-once HD DVD-R, and a rewritable HD-DVD-RW or HD DVD RAM use a multi pulse type recording strategy as illustrated in (c) of FIG. 1.

The recording strategy largely influences recording/reproduction performance of an optical disc, and therefore it is important to adjust the recording strategy (output level and pulse width). As a conventional technique of the recording strategy adjustment method, there are methods described in Japanese Patent Application Publications (JP-P2000-182244A and JP-P2000-30254A). In a technique described in Japanese Patent Application Publication (JP-P2000-182244A), some levels are allocated to recording power or parameters of the recording strategy, and experiments are exhaustively performed in various combinations to select an optimal level. In a technique described in Japanese Patent Application Publication (JP-P2000-30254A), each of parameters and a recording power of the recording strategy is separately adjusted, and a theoretical mark length is used as a guideline to determine the recording power.

Also, Japanese Patent Application Publication (JP-P2001-155340A) describes a technique that is applicable to CAV (Constant Angular Velocity) recording, ZCAV (Zone Constant Angular Velocity) recording, or CLV (Constant Liner Velocity) recording with an arbitrary velocity, and performs recording with a simple control method. In this technique, upon formation of recording marks with a multi pulse system on an optical recording medium of which a recording linear velocity is variable, a recording power is allocated to a pulse train for forming the recording marks for each of pulse types on the basis of an emission pattern and pulse length settings that are optimized at a settable maximum linear velocity. The pulse train for forming the recording mark is adapted to be generated by two or more different recording powers allocated in this manner. Each recording power is controlled depending on the recording linear velocity or a recording position of the optical recording medium.

Also, Japanese Patent Application Publication (JP-P2003-203343A) describes a recording strategy adjustment method for a CD-R or a DVD-R, and Japanese Patent Application Publication (JP-P2005-216347A) describes a recording strategy adjustment method for a DVD-R. Further, Japanese Patent Application Publication (JP-P2004-22007A) describes a recording condition adjustment method for a DVD-RW, of which a time length of a recording mark is nT (n is a natural number equal to or more than 2, and T is a channel clock period). Still further, Japanese Patent Application Publication (JP-P2005-38473A) describes a technique for adjusting a pulse width or an output level in a pulse train type recording strategy depending on a reproduction signal quality.

A recording density of the HD DVD or Blu-ray disc as a next generation DVD is very high (three or more times) as compared with a conventional DVD, and a PRML (Partial Response Maximum Likelihood) technique is used to read a signal. The PRML technique is one that preliminarily estimates interference between recording signals, and predicts a signal pattern considered as likelihood to perform decoding. A technique related to the PRML technique is described in Technical Digests of ODS 2001 (2001 p. 145) by M. Nakano et al.

In the HD DVD, there is used a PRML of PR (1, 2, 2, 2, 1), which is of a very large interference class. This means that states of edges of adjacent recording marks largely influence a reproduction signal. This also means that adjustment of a recording strategy is difficult.

In case where a PRML detection is performed, there are some indices for evaluating a signal quality of a reproduction signal waveform (reproduction signal quality). One of the indices is a PRSNR (Partial Response Signal to Noise Ratio). This is an index instead of a jitter that has been used for evaluation of the signal quality of a reproduction signal waveform in the conventional DVD.

The PRSNR is an index indicating an SNR (Signal to Noise Ratio) in a PRML system. This is the index obtained by calculating a ratio between a difference between an RF signal and an ideal signal obtained from a Viterbi decoding result and a Euclidean distance between paths.

Here, with respect to a path that has a short Euclidean distance and is therefore a bottleneck in a system, a calculation is performed by using the following equation (1). If there are a plurality of bottleneck paths, the calculations are separately performed by using the equation (1) with respect to distances between the respective paths. In this case, a value of a path that is minimum among a results of the calculations based on the equation (1) is provided as a PRSNR in the corresponding PRML system.

$$\frac{{( {\sum }_{m} {ɛ}_{m}^{2} )}^{2}}{E [ {( {\sum }_{m} {ɛ}_{m} {n}_{m} )}^{2} ]} \qquad ( 1 )$$

where E [ ] represents an expectation. The expectation is an expected value for a case where the following equation (2) is calculated for each time, and may be considered as a mean value.

$${\sum }_{m} {ɛ}_{m} {n}_{m} \qquad ( 2 )$$

In the PRSNR for PR(1, 2, 2, 2, 1), three types of vectors ε, i.e., ε1=(1, 2, 2, 2, 1), ε2=(1, 2, 1, 0, −1, −2, −1), and ε3=(1, 2, 1, 0, 0, 0, 1, 2, 1) are selected, and the equation (1) is calculated for each of the three type of vectors ε. The minimum value among three calculation results obtained here is used as a PRSNR value. The PRSNR means that as the value thereof becomes higher, the signal quality is higher, and is opposite to a jitter or an error rate. Details are described in “Signal-to-Noise Ratio in a PRML Detection” (Japanese Journal of Applied Physics 2004, vol. 43, No. 7B, pp. 4859-4862) by S. OHKUBO et al.

In the high-density optical disc such as the HD DVD or the Blu-ray disc, it is difficult to use a jitter value as an evaluation index. For example, a reproducing operation is performed on the HD DVD disc by use of an optical head in which NA (numerical aperture) of an objective lens is 0.65, and a wavelength of a laser beam is 405 nm. In this case, a resolution defined by a ratio of a long mark amplitude and a short mark amplitude becomes −30 dB or less, which is extremely small. For this reason, if binarization is performed by a slicer system as in a conventional technique, separation of a 2T signal forming a minimum mark (or space) is of course difficult, and even a 3T signal is difficult to separate. Accordingly, an optical disc apparatus using the HD DVD or Blu-ray disc employs the PRSNR as a performance evaluation index.

For this reason, in case of adjusting a recording strategy in the optical disc apparatus using the high-density optical recording medium such as the HD DVD disc and the Blu-ray disc, a technique suitable for PRML is required, which is not used for the conventional DVD. In a method described in Japanese Patent Application Publication (JP-P2000-182244A), a recording strategy is adjusted with coarse accuracy under the assumption that each parameter independently influences signal quality. However, in case of the high-density optical recording medium, a recording mark is small, and therefore a variation in signal quality is adjusted on the basis of some parameters (e.g., output level) of the recording strategy that influences an adjustment of the signal quality based on the other parameters (e.g., pulse width). For this reason, it is difficult to obtain an optimal recording strategy by the method described in Japanese Patent Application Publication (JP-P2000-182244A). Also, in case of the HD DVD or Blu-ray disc, a distance between recording marks is short as compared with the conventional DVD, and therefore edges of the adjacent recording marks influence each other. For this reason, it is difficult to obtain an optimal recording strategy by a method described in Japanese Patent Application Publication (JP-P2000-30254A) in which a theoretical mark length is used as a guideline to adjust a recording power.

Also, in a technique described in Japanese Patent Application Publication (JP-P2001-155340A), a recording strategy is adjusted by not the PRML detection but the slice detection (binary detection). Such a technique cannot be applied to a system using the PRML. Similarly, techniques described in Japanese Patent Application Publications (JP-P2003-203343A and JP-P2005-216347A) are adjustment methods not envisaging the PRML detection but using the traditional jitter.

Because of such situations, it is required to clarify an adjustment method for a recording strategy or an adjustment sequence of recording strategy parameters in the high-density system using the PRML, such as the HD DVD or Blu-ray disc.

### DISCLOSURE OF INVENTION

It is an object of the present invention to provide a recording condition adjusting method and an optical disc apparatus in which a recording strategy of a laser beam for recording information on a high-density optical information recording medium is optimally adjusted.

Another object of the present invention is to provide a recording condition adjusting method that optimally adjusts a recording strategy of a laser beam for recording information in an optical disc apparatus using a PRML technique for reading a signal.

Still another object of the present invention is to provide a recording condition adjusting method and an optical disc apparatus, in which an adjustment time of a recording strategy for recording information on an optical information recording medium can be shortened.

An optical disc apparatus according to the present invention is an information recording/reproduction apparatus that records information on an optical information recording medium with a laser beam having a pulse train type recording strategy. The optical disc apparatus according to the present invention includes a recording strategy adjustment section having an initial value setting section; an output level setting section; and a pulse width setting section. The initial value setting section sets initial values of pulse widths and output levels of a recording strategy as a basic recording strategy. Also, the output level setting section adjusts output levels of the recording strategy with a plurality of first adjustment laser beams that are outputted by changing the output levels of the basic recording strategy. Also, the pulse width setting section adjusts the pulse widths of the recording strategy with a plurality of second adjustment laser beams that are outputted by fixing the output levels set by the initial value setting section, and changing the pulse widths of the basic recording strategy. As described, the optical disc apparatus according to the present invention can set the recording strategy having good reproduction signal quality by adjusting the output levels first and then the pulse widths by use of the set basic recording strategy.

Also, the recording strategy according to the present invention preferably has a first pulse and a second pulse. In this case, the initial value setting section sets respective initial values of a first pulse width of the first pulse, a second pulse width of the second pulse, and output levels of a laser beam. The output level setting section changes the output levels of the basic recording strategy to output a plurality of first adjustment laser beams, and obtains a plurality of first reproduction signal qualities from the optical information recording medium with the plurality of first adjustment laser beams. Also, the output level setting section sets the output levels corresponding to the best reproduction signal quality among the plurality of first reproduction signal qualities as the output levels of the recording strategy. Then, the pulse width setting section outputs a plurality of second adjustment laser beams by fixing the output levels set in the output level setting section, fixing a ratio between the first pulse width and the second pulse width to a ratio set in the basic recording strategy, and changing the first pulse width and second pulse width. The pulse width setting section obtains a plurality of second reproduction signal qualities from the optical information recording medium with the second adjustment laser beams, and sets a first pulse width and a second pulse width corresponding to a best reproduction signal quality among the plurality of second reproduction signal qualities as the first pulse width and the second pulse width of the recording strategy. Thus, by using the basic recording strategy, of which the pulse width ratio is fixed, to adjust a recording condition, the high accuracy adjustments become possible in a short time.

The initial values of the second pulse width and the output level according to the present invention are preferably values uniquely determined depending on the initial value of the first pulse width. In this case, the number of parameters to be set is reduced, and narrowing down of an optimal recording condition is simplified.

Preferably, the first pulse according to the present invention is a top pulse in the recording strategy, and the second pulse is the other pulse temporally subsequent to the top pulse.

The initial value setting section according to first and second aspects obtains a plurality of third reproduction signal qualities from the optical information recording medium with a plurality of third adjustment laser beams corresponding to a plurality of recording strategies in which a ratio between the first pulse width and the second pulse width is constant, and sets a recording strategy corresponding to the best reproduction signal quality among the plurality of third reproduction signal qualities as the basic recording strategy.

The initial value setting section according to a third aspect sets the basic recording strategy with a first pulse width set in a recording strategy recorded on the optical information recording medium being used in advance as an initial value.

The initial value of the output level and the initial value of the first pulse width are preferably in a proportional relationship having a negative proportionality coefficient.

The output level setting section according to the first aspect outputs a plurality of fourth adjustment laser beams in which the first pulse width and the second pulse width set in the pulse width setting section are fixed, and the output levels are changed. Also, preferably, the output level setting section obtains a plurality of fourth reproduction signal qualities from the optical recording medium with the plurality of fourth adjustment laser beams, and sets output levels corresponding to the best reproduction signal quality among the plurality of fourth reproduction signal qualities as the output levels of the recording strategy.

On the optical information recording medium, information is recorded by a mark formed according to a laser beam. In case where a mark length of the mark is nT (T is a channel clock period, and n is a natural number equal to or more than 2), the recording strategy preferably includes a group of (n−1) pulses.

As described above, according to the recording condition adjusting method and the optical disc apparatus of the present invention, a recording strategy of a laser beam for recording information on a high-density optical information recording medium can be optimally adjusted.

Also, in an optical disc apparatus using a PRML technique to read a signal, a recording strategy of a laser beam for recording information can be optimally adjusted.

Further, an adjustment time of a recording strategy for recording information on an optical information recording medium can be shortened.

### BRIEF DESCRIPTION OF DRAWINGS

The above-mentioned objects, effects, and features of the invention will be further clarified from descriptions of exemplary embodiments in collaboration with the accompanying drawings.

FIG. 1 is a diagram illustrating a recording strategies of a laser beam for recording information on an optical information recording medium;

FIG. 2 is a block diagram illustrating a configuration of an optical disc apparatus according to a first exemplary embodiment of the present invention;

FIG. 3 is a diagram illustrating a configuration of a recording strategy adjusting section according to the first exemplary embodiment of the present invention;

FIG. 4 is a block diagram illustrating a configuration of an RF circuit according to the first exemplary embodiment of the present invention;

FIG. 5 is a flowchart illustrating an operation of a recording condition adjusting process according to the present invention;

FIG. 6 is a characteristic diagram illustrating relationships between a top pulse width and output levels in an optimal recording strategy for an optical information recording medium;

FIG. 7 is a diagram illustrating an example of recording strategies prepared to set a basic recording strategy;

FIG. 8 is a diagram illustrating PRSNRs corresponding to the recording strategies prepared to set the basic recording strategy;

FIG. 9 is a characteristic diagram illustrating a correspondence between a recording power used for an output level adjustment and PRSBR;

FIG. 10 is a characteristic diagram illustrating a relationship between a bias power used for an output level adjustment and PRSBR;

FIG. 11 is a characteristic diagram illustrating a relationship between a top pulse width used for a pulse width adjustment and PRSBR;

FIG. 12 is a diagram illustrating a comparison between ideal values of an optimal recording strategy and those of a recording strategy adjusted according to the present invention;

FIG. 13 is a characteristic diagram illustrating a relationship between a top pulse width and PRSNR when a sequence of an output level adjustment and a pulse width adjustment is changed;

FIG. 14 is a flowchart illustrating an operation of the recording condition adjusting process according to the first exemplary embodiment of the present invention;

FIG. 15 is a diagram illustrating recording strategy adjustment results obtained in the first exemplary embodiment of the present invention; and

FIG. 16 is a diagram illustrating basic recording strategies prepared for the recording condition adjusting process according to a second exemplary embodiment of the present invention.

### BEST MODE FOR CARRYING OUT THE INVENTION

Hereinafter, an optical disc apparatus according to the present invention will be described with reference to the attached drawings. In the drawings, the same and similar reference symbols represent the same and similar components. In the following, an optical disc apparatus using a PRML technique is taken as an example to describe the exemplary embodiments.

### First Exemplary Embodiment

### Configuration of Optical Disc Apparatus

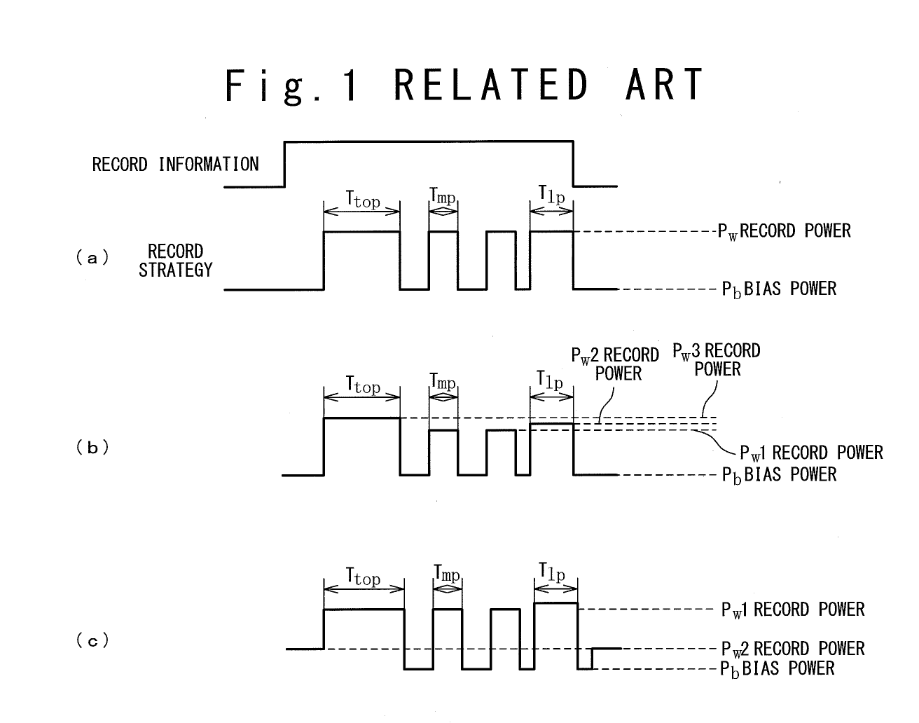

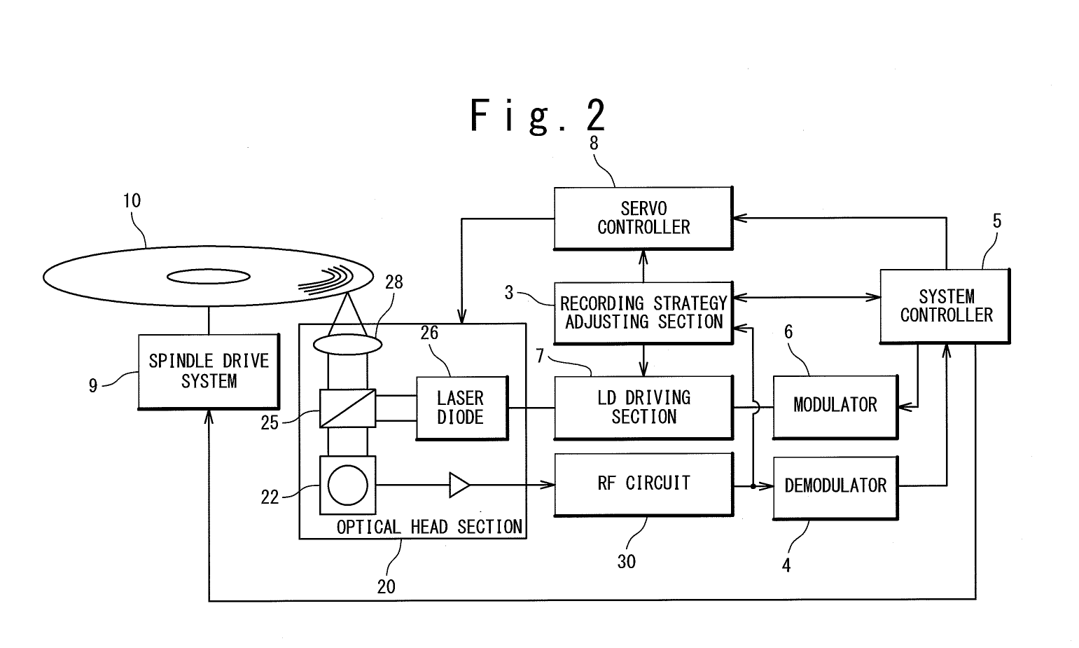

FIG. 2 is a block diagram illustrating a configuration of the optical disc apparatus according to the first exemplary embodiment of the present invention. Referring to FIG. 2, the optical disc apparatus according to the present invention is an information recording/reproduction apparatus that records/reproduces information on/from an optical disc 10 with a laser beam having a recording strategy as illustrated in (a) of FIG. 1. The optical disc apparatus according to the present invention includes a spindle drive system 9, an optical head section 20, a RF circuit 30, a recording strategy adjusting section 3, a demodulator 4, a system controller 5, a modulator 6, an LD driving section 7, and a servo controller 8.

The spindle drive system 9 drives an optical disc 10. The optical head section 20 includes a laser diode (LD) 26, a beam splitter 25, an objective lens 28, and an optical detector 22, and irradiates a laser beam to the optical disc 10 to detect a reflected beam of the laser beam. The laser beam emitted from the laser diode (LD) 26 is reflected by the beam splitter 25, and then irradiated on the optical disc 10 through the objective lens 28. The reflected beam reflected by the optical disc 10 is focused by the objective lens 28; passes through the beam splitter 25; and detected by the optical detector 22. A signal detected by the optical detector 22 is outputted to the RF circuit 30.

The RF circuit 30 executes processes such as filtering of the signal from the detector 22, and then outputs a data stream signal to the demodulator 4. Also, the RF circuit 30 calculates a PRSNR to output the calculation result to the recording strategy adjusting section 3. The recording strategy adjusting section 3 adjusts a recording strategy and determines reproduction signal performance on the basis of the PRSNR supplied from the RF circuit part 30, and sets an optimal recording strategy. Also, the recording strategy adjusting section 3 assigns the set recording strategy to the LD driving section 7. In the present exemplary embodiment, the recording strategy adjusting section 3 is provided separately from the system controller 5, but may be incorporated inside the system controller.

The demodulator 4 demodulates the data stream signal outputted from the RF circuit 30 to output it to the system controller 5. The modulator 6 modulates a signal to be recorded (recording information signal), which is supplied from the system controller 5, and outputs it to the LD driving section 7. The LD driving section 7 drives the diode 26 on the basis of the modulated recording information signal supplied from the modulator 6 and the assigned recording strategy to irradiate the laser beam to the optical disc 10. The servo controller 8 controls a servo signal that controls the optical head section 20. In the servo controller 8, a tilt correction mechanism and an aberration control mechanism are also included.

The system controller 5 controls a whole of the information recording/reproduction apparatus. The system controller 5 receives the demodulated data signal from the demodulator 4, and outputs to the modulator 6 the information signal to be recorded (recording information signal). Also, the system controller 5 retains the recording strategy set by the recording strategy adjusting section 3.

The present exemplary embodiment will be described under the assumption that an LD wavelength and an NA (numerical aperture) of the optical head section 20 are 405 nm and 0.65, respectively, and the optical disc 10 is a write-once HD DVD-R, which is recordable only once. Such an HD DVD-R is a medium of a type of which a reflectivity is decreased when recording is performed, and an optical disc of a type referred to as a High to Low medium. For a recording film of the optical disc 10, inorganic materials are used. For example, a physical structure of the optical disc 10 is configured such that on a disc-shaped transparent polycarbonate substrate having the thickness of 0.6 mm and the diameter of 12 cm, a guide groove referred to as a pregroove is formed. Also, on the substrate, a film for recording is deposited. Upon recording and reproduction of information, the laser beam of the optical disc apparatus is scanned along the guide groove on the substrate. Further, a physical format of the optical disc 10 is an in-groove format having the bit pitch of 0.15 m and the track pitch of 0.40 μm.

On the basis of the configuration as described above, the optical disc apparatus according to the present invention irradiate the laser beam to the optical disc 10 of the recording strategy illustrated in (a) of FIG. 1. The laser beam is outputted on the basis of the recording information signal outputted from the modulator 6. The optical disc apparatus reproduces the recording information signal on the basis of the reflected beam from a recording mark, and calculates the PRSNR for the reproduction signal quality. In the following, steps from the formation of the recording mark with the laser beam having the recording strategy (test recording) to the calculation of the PRSNR from a reflected laser beam are collectively referred to as test recording/reproduction.

The recording strategy adjusting section 3 recognizes a correspondence between a recording condition and the reproduction signal quality on the basis of the PRSNR sent from the RF circuit 30, and controls an adjustment sequence to adjust the recording strategy so as to be optimal. Referring to (a) of FIG. 1, the recording strategy to be adjusted by the recording strategy adjusting section 3 includes output levels (the recording power P_{w}, and the bias power P_{b}) and pulse widths (a top pulse width Tₜₒₚ, a middle pulse width Tₘₚ, and a last pulse width Tₗₚ) of the laser beam emitted onto the optical disc 10.

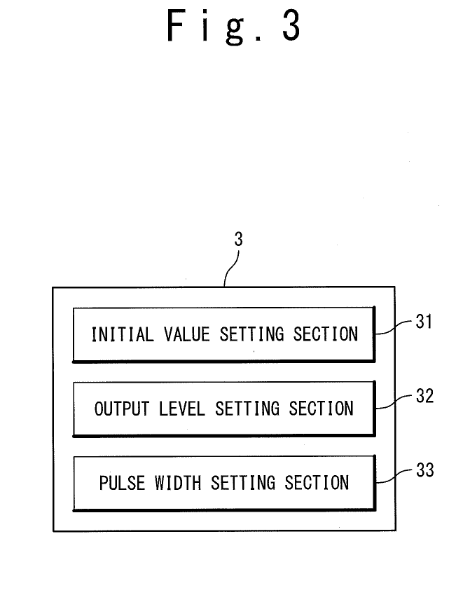

The recording strategy adjusting section 3 adjusts the recording strategy by a function as illustrated in FIG. 3. A function provided in the recording strategy adjusting section 3 includes: an initial value setting section 31 that sets initial values (basic recording strategy) of the recording strategy, which are basic values for the adjustment; an output level setting section 32 that sets the output levels in the recording strategy; and a pulse width setting section 33 that sets the pulse widths in the recording strategy. On the basis of such a function, the recording strategy adjusting section 3 utilizes the PNSNR as the reproduction signal quality to adjust the recording strategy. It should be noted that the recording strategy adjusting section 3 may utilize a PI error (Inner-code-Parity error) obtained from the data stream signal demodulated by the demodulator as the reproduction signal quality to adjust the recording strategy (not illustrated).

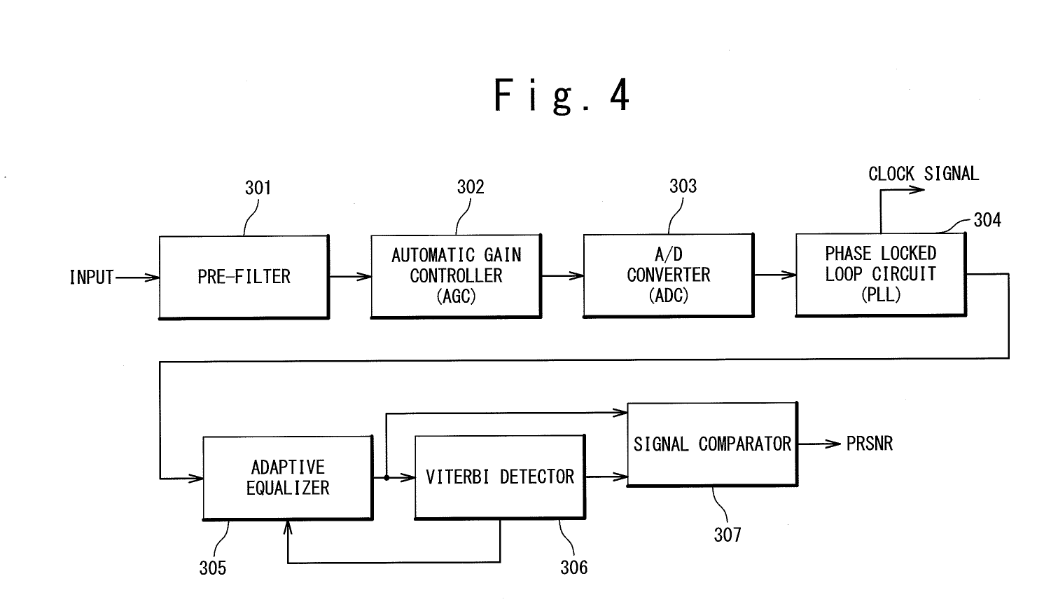

FIG. 4 is a block diagram illustrating a configuration of the RF circuit 30 related to the present invention. The RF circuit 30 includes a pre-filter 301, an AGC (Automatic Gain Controller) 302, an ADC (A/D Converter) 303, a PLL (Phase Locked Loop) circuit 304, an adaptive equalizer 305, a Viterbi detector 306, and a signal comparator 307.

The pre-filter 301 filters an RF signal detected by the optical detector 22. The filtered RF signal is amplitude-corrected by the AGC 302, and 8-bit quantized, for example, and converted into a multi-valued digital information signal by the ADC 302. From the quantized digital signal, a channel clock signal is extracted by the PLL circuit 304. The tap coefficients are controlled in the adaptive equalizer 305 based on data from the Viterbi detector 306 so as to adaptively adjust a predetermined frequency characteristic on the basis of the channel clock signal. The Viterbi detector 306 performs Viterbi decoding on an equalized signal from the adaptive equalizer 305. A Viterbi decoder 36 in the present exemplary embodiment performs Viterbi decoding of PR (1, 2, 2, 2, 1). The signal comparator 307 calculates the PRSNR on the basis of the equalized signal and a Viterbi-decoded data sequence signal. A noise at each time necessary for the calculation of the PRSNR is calculated as a difference between an ideal signal (waveform) obtained by a convolution integral of the Viterbi decoded data sequence signal and (1, 2, 2, 2, 1) vector, and the adaptively equalized signal (actual signal waveform).

### (Recording Strategy Adjusting Process)

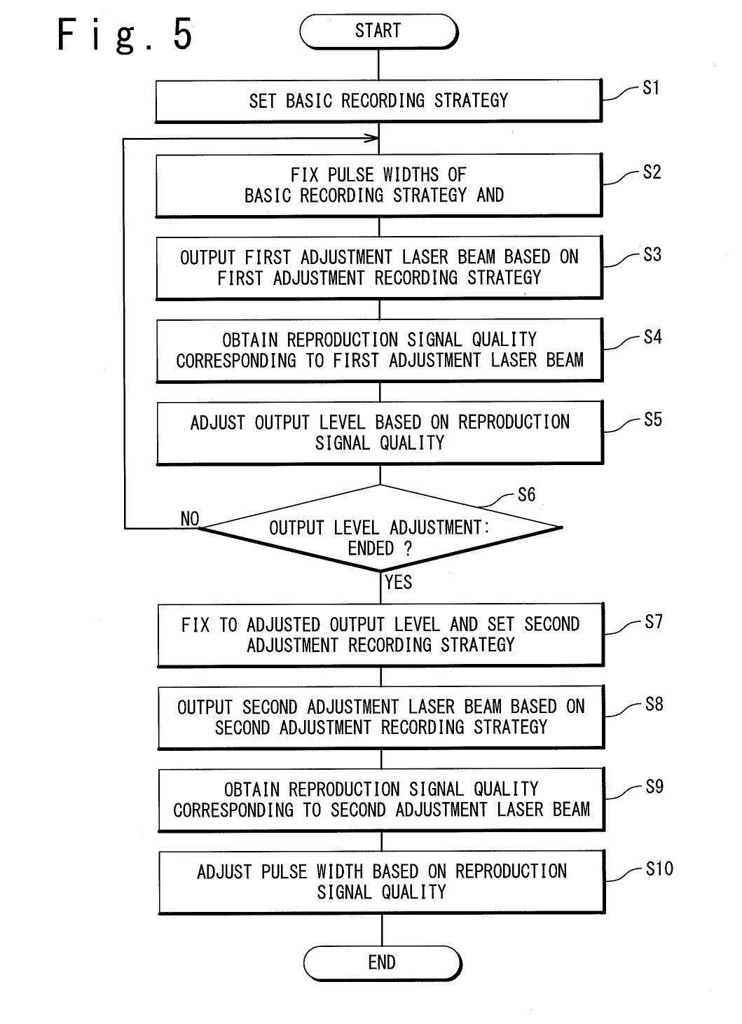

Referring FIGS. 4 to 13, an operation of a recording strategy adjusting process in the optical disc apparatus according to the first exemplary embodiment of the present invention will be described. Referring to FIG. 5, the recording strategy adjusting section 3 in the first exemplary embodiment adjusts the recording strategy on the basis of three phases, i.e., a setting of a basic recording strategy (Step S1), adjustment of the output levels (Steps S2 to S6), and adjustment of the pulse widths (Steps S7 to S10).

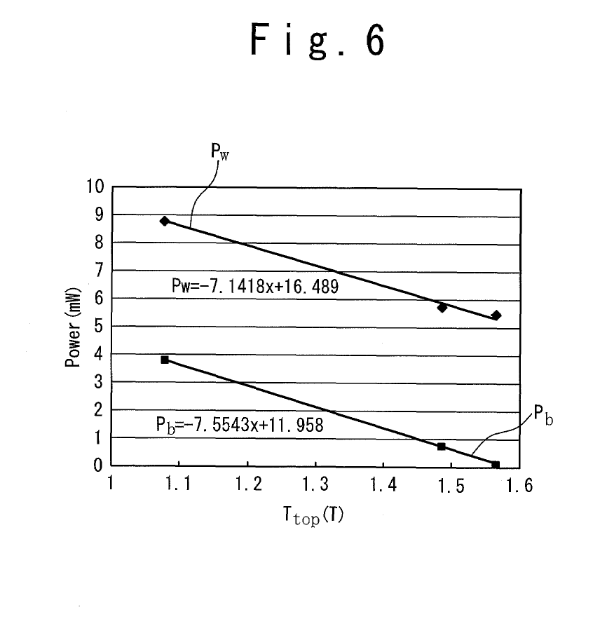

Referring to FIGS. 6 to 8, the setting of basic recording strategy in Step S1 will be described. Before the description of the setting operation of the basic recording strategy, characteristics of an optimal recording strategy for the HD DVD-R will be described. The inventors of the present application have examined the optimal recording strategies for a plurality of HD DVD-Rs manufactured by different manufacturers, and found out three characteristics.

A first characteristic is that a ratio of a top pulse width Tₜₒₚ of the optimal recording strategy, a subsequent middle pulse width Tₘₚ, and a last pulse width Tₗₚ is almost same over all of the media. According to the optical disc apparatus in the present exemplary embodiment, a pulse width ratio of an optimal recording strategy for any optical disc 10 was Tₜₒₚ:Tₘₚ:Tₗₚ=1.65:1:1.

A second characteristic is that in case of a wide pulse width, the output level is decreased, whereas in case of a narrow pulse width, the output level is increased. Relationship between the top pulse width Tₜₒₚ and the output level (the recording power P_{w} and the bias power P_{b}) in the optimal recording strategy (examination results) is illustrated in FIG. 6. Referring to FIG. 6, it can be understood that the relationship between the top pulse width Tₜₒₚ and the recording power P_{w} or the bias power P_{b} is in a proportional relationship. From the relationships illustrated in FIG. 6, the following equations (3) and (4) are obtained:

Recording power P_{w}=−7.1418×Tₜₒₚ+16.489 (3)

Bias power P_{b}=−7.5543×Tₜₒₚ+11.958 (4)

Regarding the HD DVD, a similar material is essentially used for a recording film of any medium, and a difference is only a portion contributing to diffusion of heat (mainly, reflection film). For this reason, parameters of the optimal recording strategy are different for each medium; however, it is considered that the recording strategy is determined in accordance with the above two characteristics. A recording material for achieving the recent high-density optical disc is very sophisticated, and the recording material for obtaining good recording/reproduction performance inevitably has almost the same composition. Accordingly, it is considered that, regarding media that will be delivered in the future too, many of the media are different only in thermal diffusion characteristics, and that approximations like equations (3) and (4) effectively function for other optical discs.

A third characteristic is that the middle pulse width Tₘₚ and the last pulse width Tₗₚ may take the same value, although this is associated with the first characteristic. From this, it could be understood that it is not necessary to separately examine the middle pulse width Tₘₚ and the last pulse width Tₗₚ. Accordingly, the number of the parameters to be adjusted is reduced by one, and therefore the recording strategy can be efficiently adjusted. The middle pulse width Tₘₚ and the last pulse width Tₗₚ take a same value, and therefore in the following, the middle pulse width Tₘₚ will be described while omitting a description of the last pulse width Tₗₚ.

Parameters such as a pulse width ratio, and proportionality coefficients in the equations (3) and (4) are not limited to the above-described values, but take different values if characteristics (wavelength of the laser beam, and NA (numerical aperture)) of the optical head 20, a recording film material of the optical disc 10, and the like are different. However, characteristics of the parameters (the pulse width ratio is constant, and relationship between the pulse width and the output level is in a proportional relationship) are as described above.

On the basis of the above-described characteristics, the initial value setting section 31 in the first exemplary embodiment sets the basic recording strategy as basic values upon setting of the recording strategy (Step S1).

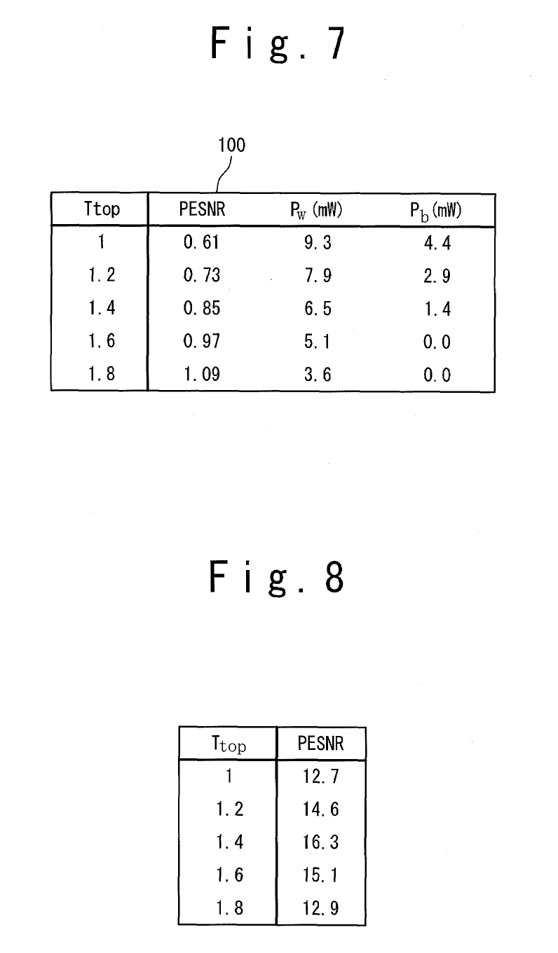

In Step S1, the initial value setting section 31 first prepares a plurality of recording strategies with a ratio of the top pulse width Tₜₒₚ, the middle pulse width Tₘₚ, and the last pulse width Tₗₚ being fixed to a predetermined ratio (e.g., 1.65:1:1). Specifically, the initial value setting section 31 prepares five top pulse widths Tₜₒₚ from 1.0T (T is a channel period) to 1.8T at intervals of 0.2T. The initial value setting section 31 uses the equations (3) and (4) to calculate a recording power P_{w} and a bias power P_{b} corresponding to the top pulse widths Tₜₒₚ, and sets a plurality of recording strategies 100 illustrated in FIG. 7. At this time, if any of the calculated sets of recording power P_{w} and bias power P_{b} indicates minus values, 0 mW is set. In this case, the bias powers P_{b} at the top pulse widths Tₜₒₚ of 1.6T and 1.8T are set to 0 mW. The optical disc apparatus performs test recording/reproduction on the optical disc 10 with laser beams respectively corresponding to the five recording strategies 100. On the basis of the test recording/reproduction, the initial value setting section 31 obtains PRSNRs respectively corresponding to the five recording strategies. The PRSNRs obtained at this time are illustrated in FIG. 8. The initial value setting section 31 sets a basic recording strategy having the best reproduction signal quality (in this case, top pulse width Tₜₒₚ=1.4T, middle pulse width Tₘₚ=0.85, recording power P_{w}=6.5, and bias power P_{b}=1.4) as the basic recording strategy.

The HD DVD is compatible with a standard using a PRML detection system, and therefore the PRSNR is used as the reproduction signal quality for determining the basic recording strategy; however, the PI error may be used. Also, the number of the recording strategies 100 prepared for the basic recording strategy is 5; however, it should be appreciated that the number is not limited to 5. Further, a temperature inside the optical disc apparatus increases with operating time, and consequently, an output power P_{w} may be decreased even in the same setting. If such a situation is concerned, the initial value setting section 31 may calibrates the output power P_{w} in the recording strategy.

Also, if there is no setting considered to be optimal among the prepared recording strategies 100 (e.g., the PRSNR curve does not have a peak, or other case), the initial value setting section 31 reattempts to set the top pulse widths Tₜₒₚ for new recording strategies 100. The initial value setting section 31 determines the basic recording strategy from the new recording strategies 100. Through such operations, a recording strategy close to an optimal strategy can be set almost surely as the basic recording strategy.

Next, the output level setting section 32 uses the basic recording strategy set by the initial value setting section 31 to adjust an output levels (the recording power P_{w} and the bias power P_{b}) of the recording strategy in more detail (Steps S2 to S6). The output level setting section 32 performs test recording/reproduction while changing the recording power and the bias power at intervals of a predetermined value based on the recording power P_{w} and the bias power P_{b} of the basic recording strategy, and selects powers that allows a best reproduction signal quality (PRSNR in this case) to be obtained.

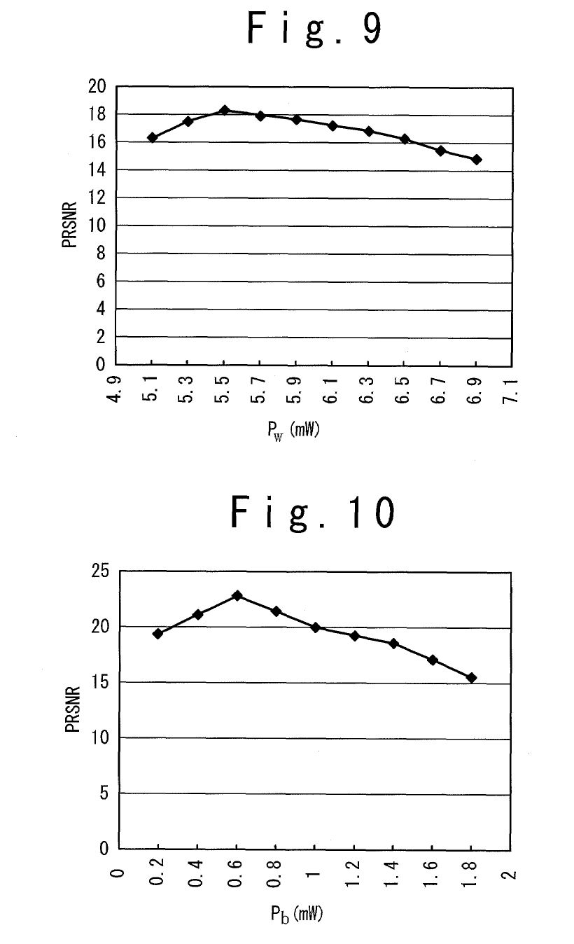

Specifically, the output level setting section 32 sets a plurality of first adjustment recording strategies in which the pulse widths (e.g., top pulse width Tₜₒₚ=1.4T, and middle pulse width Tₘₚ=0.85) in the basic recording strategy are fixed, and the recording power P_{w} are changed at intervals of 0.2 mW by using the recording power P_{w}=6.5 mW as reference (Step S2). Then, the optical disc apparatus performs test recording/reproduction on the optical disc 10 with laser beams respectively corresponding to the first adjustment recording strategies (Step S3). On the basis of the test recording/reproduction, the output level setting section 32 obtains PRSNRs respectively corresponding to the first adjustment laser beams (Step S4). The PRSNRs obtained at this time are illustrated in FIG. 9. The output level setting section 32 sets the recording power P_{w} (=5.5 mW) corresponding to the highest PRSNR as the recording power P_{w} of the recording strategy (Step S5).

Subsequently, upon completion of the adjustment of the recording power P_{w}, the output level setting section 32 adjusts the bias power P_{b} (Step S6: No). The output level setting section 32 sets a plurality of first adjustment recording strategies in which the pulse widths (e.g., top pulse width Tₜₒₚ=1.4T, and middle pulse width Tₘₚ=0.85) in the basic recording strategy are fixed, and the bias power P_{b} is changed at intervals of 0.2 mW by using the bias power P_{b}=1.4 mW as reference (Step S2). Then, the optical disc apparatus performs test recording/reproduction on the optical disc 10 with laser beams respectively corresponding to the set first adjustment recording strategies (Step S3). On the basis of the test recording/reproduction, the output level setting section 32 obtains PRSNRs respectively corresponding to the first adjustment laser beams (Step S4). The PRSNRs obtained at this time are illustrated in FIG. 10. The output level setting section 32 sets the bias power P_{w} (=0.6 mW) corresponding to a highest PRSNR as the recording power P_{w} of the recording strategy (Step S5).

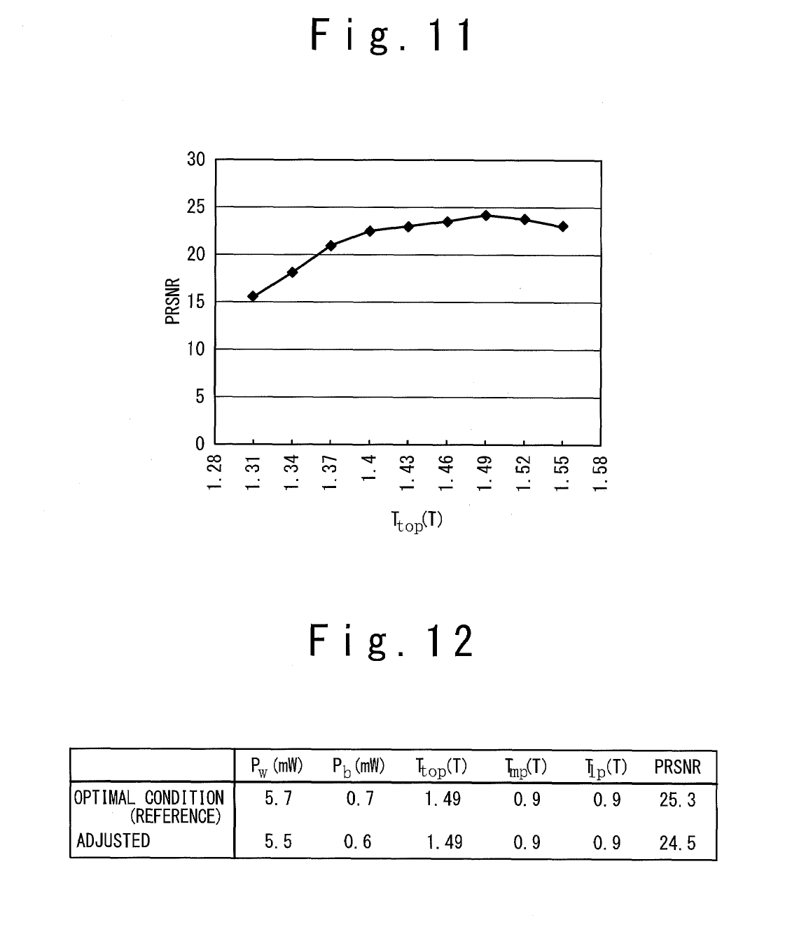

Upon completion of the adjustments of the output levels (the recording power P_{w} and the bias power P_{b}) (Step S6: Yes), a pulse width adjustment is made by the pulse width setting section 33 (Steps S7 to S10). The pulse width setting section 33 sets a plurality of second adjustment recording strategies in which the output levels (e.g., recording power P_{w}=5.5 mW, and bias power P_{b}=0.6 mW) set in Step S5 are fixed, the pulse width ratio remains fixed to Tₜₒₚ:Tₘₚ:Tₗₚ=1.65:1:1, and a pulse width is changed (Step S7). In this case, the plurality of second adjustment recording strategies are set in which the top pulse width Tₜₒₚ is changed at intervals of 0.03T by using the top pulse width Tₜₒₚ=1.4T set in the basic recording strategy as reference. Then, the optical disc apparatus performs test recording/reproduction on the optical disc 10 with laser beams respectively corresponding to the set second adjustment recording strategies (Step S8). On the basis of the test recording/reproduction, the pulse width setting section 33 obtains PRSNRs respectively corresponding to the second adjustment laser beams (Step S9). The PRSNRs obtained at this time are illustrated in FIG. 11. The pulse width setting section 33 sets a top pulse width Tₜₒₚ (=1.49T) corresponding to the highest PRSNR as the top pulse width Tₜₒₚ of the recording strategy (Step S10). It should be noted that the pulse width ratio is fixed to 1.65:1:1, and therefore the middle pulse width Tₘₚ and the last pulse width Tₗₚ are uniquely determined on the basis of the top pulse width Tₜₒₚ.

As described above, the recording strategy of the laser beam that the optical disc apparatus uses for the optical disc 10 is adjusted. FIG. 12 illustrates the recording strategy adjusted according to the present invention. As reference, there is illustrated an optimal recording strategy that is adjusted and obtained for the same optical disc 10 by a rigorous method such that the PRSNR is maximized. As illustrated in FIG. 12, the recording strategy adjusted according to the present invention has had values approximate to those of the optimal recording strategy. Thus, according to the present invention, a good recording condition approximate to the rigorously adjusted optimal recording strategy can be obtained by a simple method. Although not illustrated, similar results have also been obtained for optical discs manufactured by other manufacturers. Therefore, according to the present invention, a recording condition can be simply set with high accuracy for an optical disc utilizing the PRML detection.

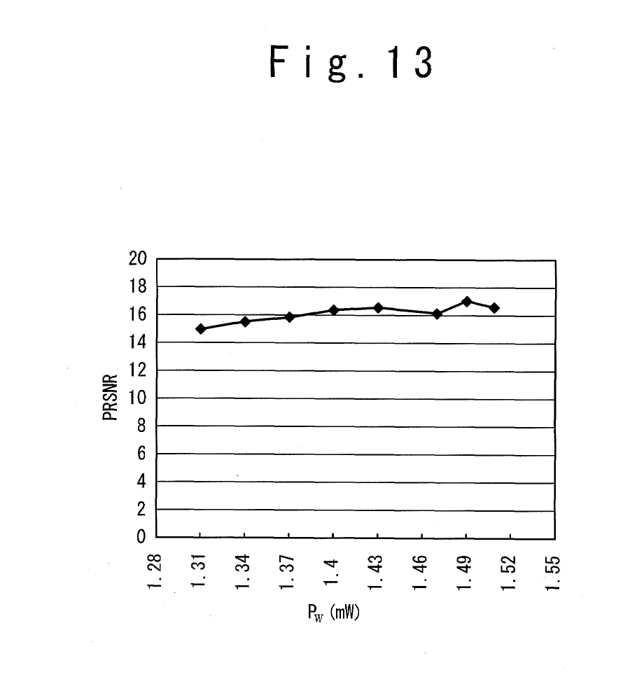

As a reference, FIG. 13 illustrates a variation in a reproduction signal quality for a case where the pulse width adjusting operation in Steps S7 to S10 is performed before the output level adjusting operation in Steps S2 to S6. In this case, the pulse width setting section 33 sets the second adjustment recording strategies with the recording power P_{w} and the bias power P_{b} in the basic recording strategy being fixed. As illustrated in FIG. 13, even if the top pulse width Tₜₒₚ is changed with the pulse width ratio being fixed, the PRSNR exhibits almost a constant value, and therefore it is difficult to determine optimal pulse widths. For this reason, the output level adjustment is preferably made before the pulse width adjustment. It should be noted that a sequence for making the recording power P_{w} adjustment and the bias power P_{b} adjustment may be reversed.

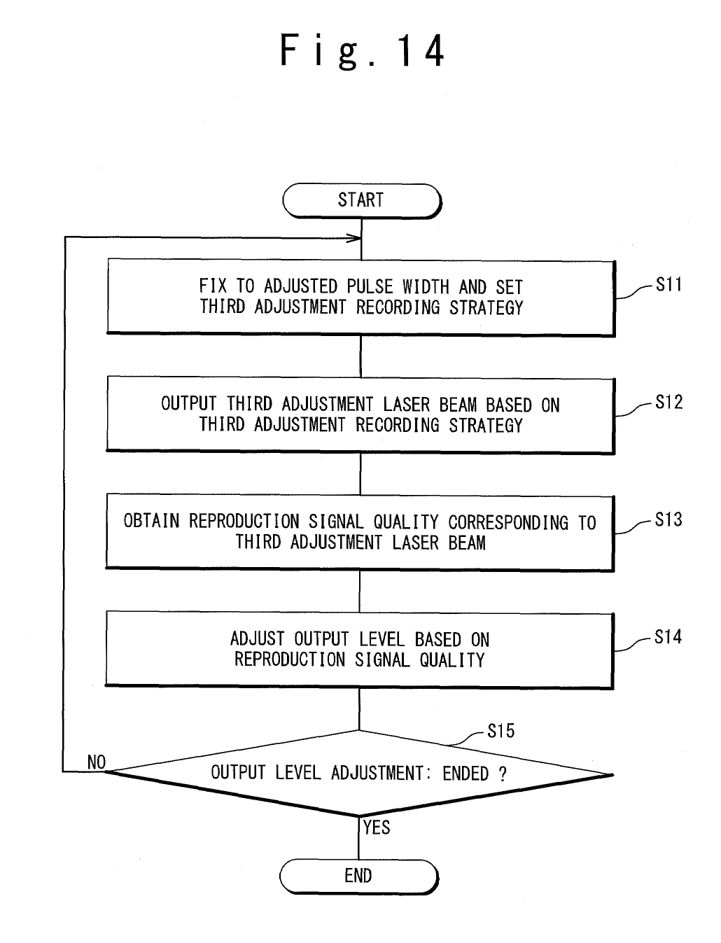

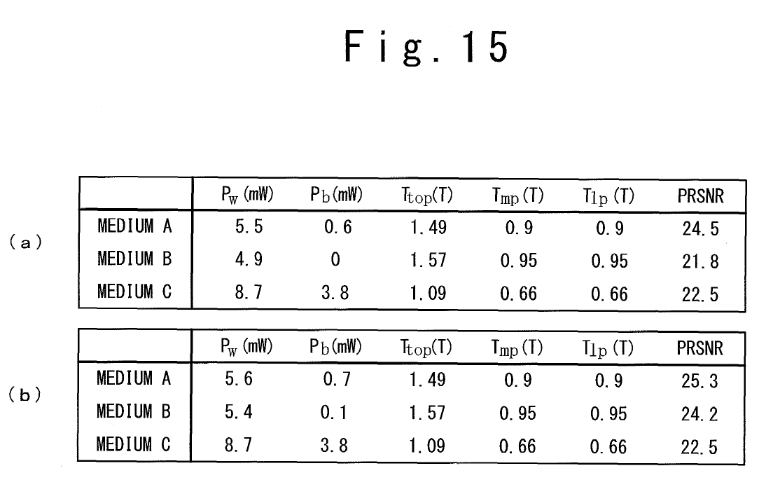

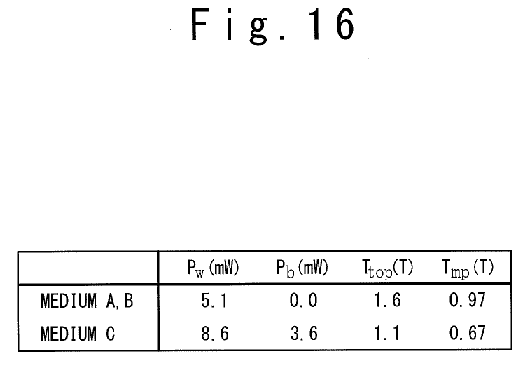

To adjust the recording condition (recording strategy) with higher accuracy, the recording power P_{w} and the bias power P_{b} may be again adjusted after Step S10 (FIG. 14, Steps S11 to S15). In this case, the output level setting section 32 sets a plurality of third adjustment recording strategies in which the pulse widths (e.g., top pulse width Tₜₒₚ=1.49T, middle pulse width Tₘₚ=0.9T, and last pulse width Tₗₚ=0.9T) set in the pulse width setting section 33 are fixed, and the recording power P_{w} is changed at intervals of a predetermined value by using the recording power P_{w}=5.7 mW as reference (Step S11). Then, the optical disc apparatus performs test recording/reproduction on the optical disc 10 with laser beams respectively corresponding to the set third adjustment recording strategies (Step S12). On the basis of the test recording/reproduction, the output level setting section 32 obtains PRSNRs respectively corresponding to the third adjustment laser beams (Step S13). The output level setting section 32 sets the recording power P_{w} (=5.6 mW) corresponding to the highest PRSNR among the obtained PRSNRs as the recording power P_{w} of the recording strategy (Step S15). Upon completion of the adjustment of the recording power P_{w}, the output level setting section 32 adjusts the bias power P_{b} (Step S15: No). The output level setting section 32 sets the plurality of third adjustment recording strategies in which the pulse widths are similarly fixed, and the bias power P_{b} is changed at intervals of a predetermined value by using the bias power P_{b}=0.6 mW as reference (Step S11). Then, the optical disc apparatus performs test recording/reproduction on the optical disc 10 with laser beams respectively corresponding to the set third adjustment recording strategies (Step S12). On the basis of the test recording/reproduction, the output level setting section 32 obtains PRSNRs respectively corresponding to the third adjustment laser beams (Step S13). The output level setting section 32 sets a bias power P_{w} (=0.7 mW) corresponding to the highest PRSNR among the obtained PRSNRs as the recording power P_{w} of the recording strategy (Step S14).

The recording strategies obtained through the above-described adjustments are illustrated in (a) and (b) of FIG. 15. (a) of FIG. 15 illustrates the recording strategies adjusted through the process from Step S1 to Step S10, and (b) of FIG. 15 illustrates the recording strategies adjusted through the process from Step S1 to Step S15. As can be seen from the comparison between the both diagrams, the PRSNR, i.e., the reproduction signal quality is improved for any medium by the method for readjusting the output levels. As described, by making the output level adjustments again, a further optimal recording condition for recording/reproduction on the HD DVD can be set. To obtain the further optimal recording condition, it is preferable to select the method for adjusting the output levels again after the pulse width adjustment. Which one of the above-described methods should be employed can be determined by a drive designer on the basis of a balance between a time constraint necessary for the adjustments and adjustment accuracy.

Also, referring to FIG. 15, according to the present invention, the optimal recording condition can be set for any medium (any of optical discs manufactured by different manufacturers).

### Second Exemplary Embodiment

An optical disc apparatus in a second exemplary embodiment retains one or a plurality of basic recording strategies in advance, and uses them to set an optimal recording strategy for an inserted optical disc 10. In the optical disc apparatus in the second exemplary embodiment, a configuration except for an initial value setting section 31, and operations thereof are the same as those in the first exemplary embodiment. Therefore, in the following, operation of the initial value setting section 31 is only described.

In the optical disc apparatus in the first exemplary embodiment, an optimal recording strategy can be adjusted for an optical disc having any medium. For this reason, the optical disc apparatus can effectively function for a newly developed optical disc, too. On the other hand, depending on a design concept, there is an optical disc apparatus that is only required to be able to adjust an optimal recording condition for an existing optical disc. In the second exemplary embodiment, by narrowing down optical discs to be used, and basic recording strategies for the narrowed optical discs are prepared, a time necessary for basic strategy setting processing is shortened.

Specifically, for example, two basic recording strategies are prepared for three types of optical discs 10, i.e., media A, B, and C. In the present exemplary embodiment, the basic recording strategy (e.g., recording power P_{w}=5.1 mW, bias power P_{b}=0.0 mW, top pulse width Tₜₒₚ=1.6T, and middle pulse width Tₘₚ=0.97) for the media A and B, and the basic recording strategy (e.g., recording power P_{w}=8.6 mW, bias power P_{b}=3.6 mW, top pulse width Tₜₒₚ=1.1T, and middle pulse width Tₘₚ=0.67) for the medium C are prepared. In this example, optimal recording strategies for the media A and B are similar to each other, and therefore the same basic recording strategy is set. A basic recording strategy may be different for each medium; however, in case that many parameters are in common, the same basic recording strategy is preferably used. Essentially, it is only necessary to check existing media upon delivery of the optical disc apparatus to prepare some recording strategies.

In Step S1, the initial value setting section 31 in the present exemplary embodiment performs test recording/reproduction based on the two types of basic recording strategies to set any one of the two strategies, which exhibits better performance, as a basic recording strategy used for adjustments. A process in Step 2 and the subsequent steps is the same as that in the first exemplary embodiment, and therefore description thereof is omitted.

As described, according to the optical disc apparatus in the second exemplary embodiment, a basic recording strategy can be set to set an optimal recording condition for a specific optical disc in a short time. Also, optimal recording strategies for current high-density optical discs are slightly different from one another because of variations in medium and optical head upon mass production. For this reason, the recording strategy adjustment as described above improves reliability of recording/reproduction.

It should be noted that the number of basic recording strategies to be prepared may be one. In this case, the initial value setting section 31 may not be provided in the optical disc apparatus (Step S1 may be omitted). Such an optical disc apparatus is highly likely to be unable to make adjustments depending on the optical disc to be inserted, but has an advantage of being able to adjust a recording condition at very high speed for a specific optical disc 10.

Also, the first and second exemplary embodiments may be combined. In this case, the initial value setting section 31 preferably has thresholds of reproduction signal quality for selecting any one of the adjustment methods according to the first and second exemplary embodiments. The initial value setting section 31 typically selects a basic recording strategy to be used from basic recording strategies prepared as in the second exemplary embodiment. At this time, in case where values of reproduction signal quality for the basic recording strategies are lower than predetermined thresholds, the initial value setting section 31 sets a basic recording strategy to adjust a recording condition as in the first exemplary embodiment. According to such an optical disc apparatus, in case where a specific optical disc is inserted, a recording condition can be adjusted in a shorter time than in the first exemplary embodiment, whereas in case where the other optical disc is inserted, a recording condition can be adjusted with higher accuracy than in the second exemplary embodiment.

### Third Exemplary Embodiment

An optical disc apparatus in a third exemplary embodiment includes an initial value setting section 31 that uses a recording strategy written on an optical disc 10 to set a basic recording strategy. In the optical disc apparatus in the third exemplary embodiment, a configuration excluding the initial value setting section 31, and operation thereof are the same as those in the first exemplary embodiment. Therefore, in the following, only operation of the initial value setting section 31 will be described.

A general optical disc has an information management area inside a medium thereof, and often has a recommended recording strategy as information. However, the recommended recording strategy has a value that was examined with a tester head different from an optical head mounted in an actual optical disc apparatus. For this reason, at present, the recommended recording strategy cannot be directly used as a recording strategy of a laser beam. The initial value setting section 31 in the third exemplary embodiment uses the recommended recording strategy recorded on an optical disc 10 to set as the basic recording strategy. For example, the initial value setting section 31 divides a top pulse width Tₜₒₚ in the recommended recording strategy by 1.65 to calculate a middle pulse width Tₘₚ and the last pulse width Tₗₚ, and sets them as the basic recording strategy. It should be appreciated that the middle pulse width Tₘₚ of the recommended recording strategy may be used to set the basic recording strategy.

A recording strategy to be adjusted according to the present invention preferably has (m−1) pulses (m is a natural number equal to or more than 2) for a recording mark having the length of mT, but may have (n−2) pulses (n is a natural number equal to or more than 3). Also, the optical disc apparatus according to the present invention can use, as a modulation code, ETM (Eight to Twelve Modulation) employed in the HD DVD, or even another modulation code in the same manner. If another modulation code is used, for example, a shortest data length may be nT.

As above, the exemplary embodiments of the present invention have been described in detail; however, a specific configuration is not limited to any one of those in the above-described exemplary embodiments, but any configuration may be included in the present invention even if any modification without departing from the scope of the present invention is made. For example, the present invention can be applied to an optical disc apparatus using the Blu-ray, in addition to the HD DVD. Also, the present invention is not limited to the wavelength of 405 nm and NA of 0.65, but can be applied to any wavelength or NA. Further, in the above-described exemplary embodiments, the PR (12221) class has been used; however, the other class such as PR (1221) can be used in the same manner. Still further, as another method for evaluating the reproduction signal quality, there is a method that directly evaluates an error rate or a PI error as an index. The PI error refers to the total number of rows in which errors are detected by an inner side parity of an ECC (Error correction code), and used in qualitatively almost the same sense as the error rate. In this case, the recording strategy adjusting section 3 uses the PI error supplied from the demodulator 4 to adjust a recording strategy (not illustrated).

What is claimed is:

1-18. (canceled)

19. A recording strategy adjusting method in an optical disc apparatus which records information on an optical information recording medium with a laser beam having a pulse train type recording strategy, said method comprising:
setting initial values of pulse widths and output levels of a recording strategy as a basic recording strategy;
adjusting the output levels of said recording strategy with a plurality of first adjustment laser beams that are outputted by changing the output levels of the basic recording strategy; and
adjusting the pulse widths of said recording strategy with a plurality of second adjustment laser beams that are outputted by fixing the adjusted output levels and changing the pulse widths of said basic recording strategy,
wherein said recording strategy has a first pulse and a second pulse,
said setting a basic recording strategy comprises:
setting initial values of a first pulse width of the first pulse, a second pulse width of the second pulse, and output levels of said recording strategy as said basic recording strategy;
said adjusting output levels of said recording strategy comprises:
changing the output levels of said basic recording strategy to output a plurality of first adjustment laser beams;
obtaining a plurality of first reproduction signal qualities from said optical information recording medium with the plurality of first adjustment laser beams; and
setting the output levels corresponding to the best reproduction signal quality among the plurality of first reproduction signal qualities as the output levels of said recording strategy,
said adjusting pulse widths of said recording strategy comprises:
outputting a plurality of second adjustment laser beams in which the first pulse width and second pulse width are changed, while fixing the output levels set in said (b3) step and fixing a ratio between the first pulse width and the second pulse width to a ratio set in said basic recording strategy;
obtaining a plurality of second reproduction signal qualities from said optical information recording medium with the plurality of second adjustment laser beams; and
setting the first pulse width and the second pulse width corresponding to a best reproduction signal quality among the plurality of second reproduction signal qualities as the first pulse width and the second pulse width of said recording strategy.

20. The recording strategy adjusting method according to claim 19, wherein the initial values of the second pulse width and the output level are uniquely determined depending on the initial value of the first pulse width.

21. The recording strategy adjusting method according to claim 20, wherein the first pulse is a top pulse in said recording strategy, and the second pulse is another pulse temporally subsequent to the top pulse.

22. The recording strategy adjusting method according to claim 19, wherein said setting said basic recording strategy comprises:
preparing a plurality of recording strategies in which a ratio between the first pulse width and the second pulse width is constant;
outputting a plurality of third adjustment laser beams corresponding to said plurality of recording strategies;
obtaining a plurality of third reproduction signal qualities from said optical information recording medium with the plurality of third adjustment laser beams; and
setting a recording strategy corresponding to a best reproduction signal quality among the plurality of third reproduction signal qualities as said basic recording strategy.

23. The recording strategy adjusting method according to claim 20, wherein said setting said basic recording strategy comprises:
acquiring a recording strategy recorded on said optical information recording medium in advance; and
setting said basic recording strategy with a first pulse width set in the recording strategy acquired in said (a15) step as the initial value.

24. The recording strategy adjusting method according to claim 20, wherein the initial value of the output level and the initial value of the first pulse width are in a proportional relationship having a negative proportionality coefficient.

25. The recording strategy adjusting method according to claim 19, further comprising:
outputting a plurality of fourth adjustment laser beams in which the first pulse width and the second pulse width set in said (c3) step are fixed, and the output levels are changed;
acquiring a plurality of fourth reproduction signal qualities from said optical recording medium based on the plurality of fourth adjustment laser beams; and
setting the output level corresponding to the best reproduction signal quality among the plurality of fourth reproduction signal qualities as the output level of the recording strategy.

26. The recording strategy adjusting method according to claim 19, wherein the information is recorded on said optical information recording medium by a mark formed based on the laser beam,
when a mark length of the mark is nT the recording strategy includes a group of (n−1) pulses, and
T is a channel clock period, and n is a natural number equal to or more than 2.

27. An optical disc apparatus which records information on an optical information recording medium with a laser beam having a pulse train type recording strategy, comprising:
an initial value setting section configured to set initial values of pulse widths and output levels of a recording strategy as a basic recording strategy;
an output level setting section configured to adjust the output levels of said recording strategy with a plurality of first adjustment laser beams that are outputted by changing the output levels of the basic recording strategy; and
a pulse width setting section configured to adjust the pulse widths of said recording strategy with a plurality of second adjustment laser beams that are outputted by fixing the adjusted output levels and changing the pulse widths of said basic recording strategy,
wherein said recording strategy has a first pulse and a second pulse,
said initial value setting section sets initial values of a first pulse width of the first pulse, a second pulse width of the second pulse, and output levels of said recording strategy as said basic recording strategy;
said output level setting section changes the output levels of said basic recording strategy to output a plurality of first adjustment laser beams, obtains a plurality of first reproduction signal qualities from said optical information recording medium with the plurality of first adjustment laser beams, and sets the output levels corresponding to the best reproduction signal quality among the plurality of first reproduction signal qualities as the output levels of said recording strategy, and
said (pulse width setting section outputs a plurality of second adjustment laser beams in which the first pulse width and second pulse width are changed, while fixing the output levels set in said output level setting section and fixing a ratio between the first pulse width and the second pulse width to a ratio set in said basic recording strategy, obtains a plurality of second reproduction signal qualities from said optical information recording medium with the plurality of second adjustment laser beams, and sets the first pulse width and the second pulse width corresponding to a best reproduction signal quality among the plurality of second reproduction signal qualities as the first pulse width and the second pulse width of said recording strategy.

28. The optical disc apparatus according to claim 27, wherein the initial values of the second pulse width and the output level are uniquely determined depending on the initial value of the first pulse width.

29. The optical disc apparatus according to claim 28, wherein the first pulse is a top pulse in said recording strategy, and the second pulse is another pulse temporally subsequent to the top pulse.

30. The optical disc apparatus according to claim 27, wherein said initial value setting section obtaining a plurality of third reproduction signal qualities from said optical information recording medium with a plurality of third adjustment laser beams corresponding to a plurality of recording strategies in which a ratio between the first pulse width and the second pulse width is constant, and sets a recording strategy corresponding to a best reproduction signal quality among the plurality of third reproduction signal qualities as said basic recording strategy.

31. The optical disc apparatus according to claim 28, wherein said initial value setting section sets said basic recording strategy with as the initial value, a first pulse width set in the recording strategy recorded on said optical information recording medium in advance.

32. The optical disc apparatus according to claim 28, wherein the initial value of the output level and the initial value of the first pulse width are in a proportional relationship having a negative proportionality coefficient.

33. The optical disc apparatus according to claim 28, wherein said output level setting section outputs a plurality of fourth adjustment laser beams in which the first pulse width and the second pulse width set in said pulse width setting section are fixed, and the output levels are changed, acquires a plurality of fourth reproduction signal qualities from said optical recording medium based on the plurality of fourth adjustment laser beams, and sets the output level corresponding to the best reproduction signal quality among the plurality of fourth reproduction signal qualities as the output level of the recording strategy.

34. The optical disc apparatus according to claim 27, wherein the information is recorded on said optical information recording medium by a mark formed based on the laser beam,
when a mark length of the mark is nT the recording strategy includes a group of (n−1) pulses, and
T is a channel clock period, and n is a natural number equal to or more than 2.
